(19) United States
(12) Patent Application Publication
(10) Pub. No.: US 2026/0135691 A1
(43) Pub. Date: May 14, 2026

(54) INFORMATION PROCESSING APPARATUS, INFORMATION PROCESSING METHOD, PROGRAM, AND COMMUNICATION SYSTEM

(71) Applicant: Sony Semiconductor Solutions Corporation, Kanagawa (JP)

(72) Inventors: Kumiko Mahara, Kanagawa (JP); Akihiko Nagao, Kanagawa (JP)

(21) Appl. No.: 18/859,419

(22) PCT Filed: Jun. 2, 2023
(86) PCT No.: PCT/JP2023/020595

§ 371 Date: Jan. 28, 2026

(30) Foreign Application Priority Data
Jun. 16, 2022 (JP) 2022-097033

(51) Int. Cl. H04L 9/08; H04L 9/32

(52) U.S. Cl. CPC H04L 9/0822; H04L 9/0891; H04L 9/3242

(57) ABSTRACT

Communication where a transmission destination apparatus of output data confirms a key switching timing used for security processing on the output data is disclosed. In one example, an information processing apparatus receives a new key transmitted from an apparatus as a transmission destination of output data by using a first communication IF in a case where a key used for security processing on the output data of each frame is updated, and a key ID which is identification information of the new key. The information processing apparatus performs the security processing using the new key, generates frame data in a predetermined format including the output data after the security processing and the key ID of the key used for the security processing, and transmits the frame data to the apparatus by using a second communication IF.

### TECHNICAL FIELD

The present technology particularly relates to an information processing apparatus, an information processing method, a program, and a communication system that enable a transmission destination apparatus of output data to confirm a key switching timing used for security processing on the output data.

### BACKGROUND ART

As a standard of the high-speed communication IF, there are mobile industry processor interface (MIPI), scalable low voltage signaling-embedded clock (SLVS-EC), and the like. The standards such as MIPI and SLVS-EC are used, for example, for data transmission between an image sensor such as a CIS and a processor such as a DSP operating as a Host.

### CITATION LIST

### Patent Document

Patent Document 1: Japanese Unexamined Patent Application Publication No. 2020-533924

### SUMMARY OF THE INVENTION

### Problems to be Solved by the Invention

In order to protect data output from an image sensor, a mechanism of data encryption or tamper detection using a MAC value or the like is used. A common key set in each of the image sensor and the processor is used for data encryption and tamper detection.

A key such as a common key used for security processing also has a usable period according to a scheme such as an algorithm to be adopted. Therefore, it is necessary to update the key before the usable period elapses.

In a case where the key is updated by key distribution from the processor serving as the Host, it is difficult for the processor side to grasp the timing at which the image sensor side switches to the updated new key.

The present technology has been made in view of such a situation, and enables a transmission destination apparatus of output data to confirm a key switching timing used for security processing on the output data.

### Solutions to Problems

An information processing apparatus according to a first aspect of the present technology includes: a first communication unit that receives a new key transmitted from an apparatus as a transmission destination of output data by using a first communication IF in a case where a key used for security processing on the output data of each frame is updated, and a key ID which is identification information of the new key; a security processing unit that performs the security processing using the new key and generates frame data in a predetermined format including the output data after the security processing and the key ID of the key used for the security processing; and a second communication unit that transmits the frame data to the apparatus by using a second communication IF.

An information processing apparatus according to a second aspect of the present technology includes: a first communication unit that transmits a new key and a key ID that is identification information of the new key to an apparatus that is a transmission source of output data by using a first communication IF in a case where a key used for security processing on the output data of each frame is updated; a second communication unit that receives frame data in a predetermined format including the output data after the security processing and the key ID of the key used for the security processing transmitted from the apparatus using a second communication IF; and a security processing unit that performs the security processing on the output data included in the frame data using the new key identified by the key ID included in the frame data.

In the first aspect of the present technology, in a case where a key used for security processing on output data of each frame is updated, a new key transmitted from an apparatus as a transmission destination of the output data using a first communication IF and a key ID which is identification information of the new key are received. In addition, the security processing using the new key is performed, frame data in a predetermined format including the output data after the security processing and the key ID of the key used for the security processing is generated, and the frame data is transmitted to the apparatus using a second communication IF.

In the second aspect of the present technology, in a case where a key used for security processing on output data of each frame is updated, a new key and a key ID that is identification information of the new key are transmitted to an apparatus that is a transmission source of the output data using a first communication IF. In addition, frame data in a predetermined format including the output data after the security processing and the key ID of the key used for the security processing transmitted from the apparatus using a second communication IF is received, and the security processing on the output data included in the frame data is performed using the new key identified by the key ID included in the frame data.

### BRIEF DESCRIPTION OF DRAWINGS

FIG. 1 is a diagram illustrating a configuration example of a communication system according to an embodiment of the present technology.

FIG. 2 is a diagram illustrating an example of key update by key distribution.

FIG. 3 is a diagram illustrating an example of data transmission by SLVS-EC.

FIG. 4 is a diagram illustrating an example of a format used for data transmission of SLVS-EC.

FIG. 5 is a sequence diagram for explaining a flow of key update.

FIG. 6 is a sequence diagram for explaining another flow of key update.

FIG. 7 is a diagram illustrating an example of information transmitted at the time of key update.

FIG. 8 is a diagram illustrating an example of a data structure of key update information.

FIG. 9 is a diagram illustrating another example of a data structure of key update information.

FIG. 10 is a sequence diagram illustrating a flow of key update using key update information.

FIG. 11 is a diagram illustrating an arrangement example of key IDs.

FIG. 12 is a diagram illustrating an arrangement example of key IDs.

FIG. 13 is a diagram illustrating an arrangement example of key IDs.

FIG. 14 is a diagram illustrating another configuration example of a communication system according to an embodiment of the present technology.

FIG. 15 is a sequence diagram for explaining a flow of key update in a multi-sensor system.

FIG. 16 is a block diagram illustrating a configuration example of an image sensor.

FIG. 17 is a block diagram illustrating a configuration example of a Host-side processor.

FIG. 18 is a sequence diagram illustrating another flow of key update using key update information.

### MODE FOR CARRYING OUT THE INVENTION

Hereinafter, modes for carrying out the present technology will be described. The description will be given in the following order.
1. Key Update in Communication System
2. Flow of Key Update
3. Processing Using Key ID
4. Application Example to Multi-Sensor System
5. Configuration of Each Apparatus
6. Modifications

### Key Update in Communication System

### Configuration Example of Communication System

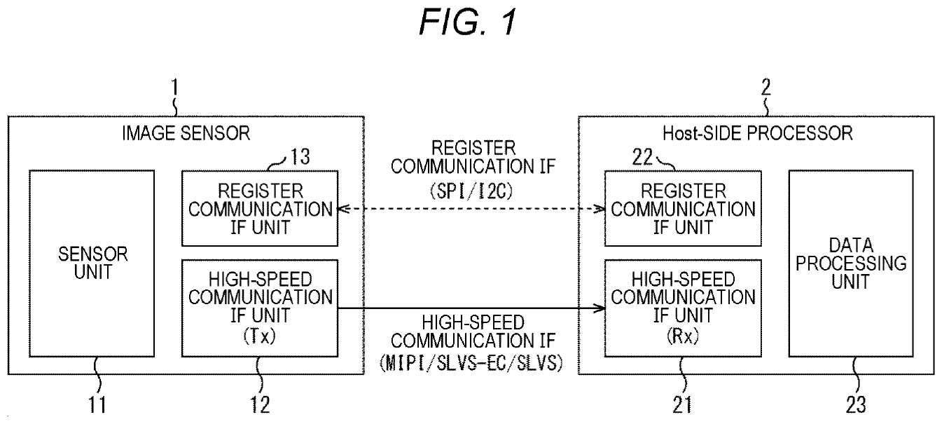

FIG. 1 is a diagram illustrating a configuration example of a communication system according to an embodiment of the present technology.

The communication system in FIG. 1 is configured by connecting an image sensor 1 and a Host-side processor 2. As will be described later, a plurality of image sensors 1 can be connected to one Host-side processor 2.

The image sensor 1 and the Host-side processor 2 may be mounted in an apparatus in the same housing such as a camera or a smartphone, or may be mounted in apparatuses in different housings.

The image sensor 1 and the Host-side processor 2 are connected by a high-speed communication IF as indicated by a solid line arrow in FIG. 1. The high-speed communication IF is a communication IF such as mobile industry processor interface (MIPI), scalable low voltage signaling-embedded clock (SLVS-EC), and scalable low voltage signaling (SLVS).

In addition, the image sensor 1 and the Host-side processor 2 are connected by the register communication IF as indicated by a broken line arrow in FIG. 1. The register communication IF is a communication IF using a register such as a serial peripheral interface (SPI) or an inter integrated circuit (I2C).

The image sensor 1 is a sensor such as a CMOS image sensor (CIS). The image sensor 1 is provided with a high-speed communication IF unit 12 and a register communication IF unit 13 in addition to a sensor unit 11 configured by arranging a plurality of pixels. In the image sensor 1, security processing such as encryption and calculation of a MAC value is performed on the image data of each frame output from the sensor unit 11.

The high-speed communication IF unit 12 transmits the image data subjected to the security processing to the Host-side processor 2 using the high-speed communication IF.

The register communication IF unit 13 performs register communication, which is communication using the register communication IF, with the Host-side processor 2. An operation mode related to shooting such as an exposure time, a gain, a resolution, and a frame rate is set by the Host-side processor 2 through register communication performed with the Host-side processor 2. In addition, a key used for security processing for image data is set by the Host-side processor 2.

The Host-side processor 2 that functions as a Host (master) for register communication is provided with a high-speed communication IF unit 21, a register communication IF unit 22, and a data processing unit 23.

The high-speed communication IF unit 21 receives image data transmitted using the high-speed communication IF.

The register communication IF unit 22 performs register communication with the image sensor 1. The register communication IF unit 22 transmits a Write command to the image sensor 1, and transmits data to the image sensor 1 by writing data in a register provided in the image sensor 1. Furthermore, the register communication IF unit 22 transmits a Read command to the image sensor 1 and reads data stored in the register to receive the data transmitted from the image sensor 1.

The data processing unit 23 including a CPU and the like processes image data transmitted from the image sensor 1 and received by the high-speed communication IF unit 21. In the data processing unit 23, security processing such as decryption of the encrypted image data and tamper detection using the MAC value is performed.

In this manner, the image sensor 1 and the Host-side processor 2 are connected by the two communication IFs of the high-speed communication IF and the register communication IF. The high-speed communication IF is used to transmit and receive data having a large data amount such as image data, and the register communication IF is used to transmit and receive data having a small data amount such as information regarding setting of an operation mode.

### Update of Key

In the image sensor 1 and the Host-side processor 2, security processing such as encryption/decryption of image data and tamper detection using a MAC value is performed by, for example, a common key encryption scheme. The update deadline of the key that is the common key is different for each mode of advanced encryption standard (AES), for example.

Key update methods generally include key distribution and key derivation.

The key distribution is a method in which the Host transmits a key to the sensor at an arbitrary timing to update the key. In the sensor, a setting for using the key received from the Host for subsequent security processing is performed.

The key derivation is a method in which the Host and the sensor derive and update a key at a preset update timing. An arbitrary timing such as a timing at which a predetermined number of pieces of image data are transmitted is set in advance as a key update timing between the Host and the sensor.

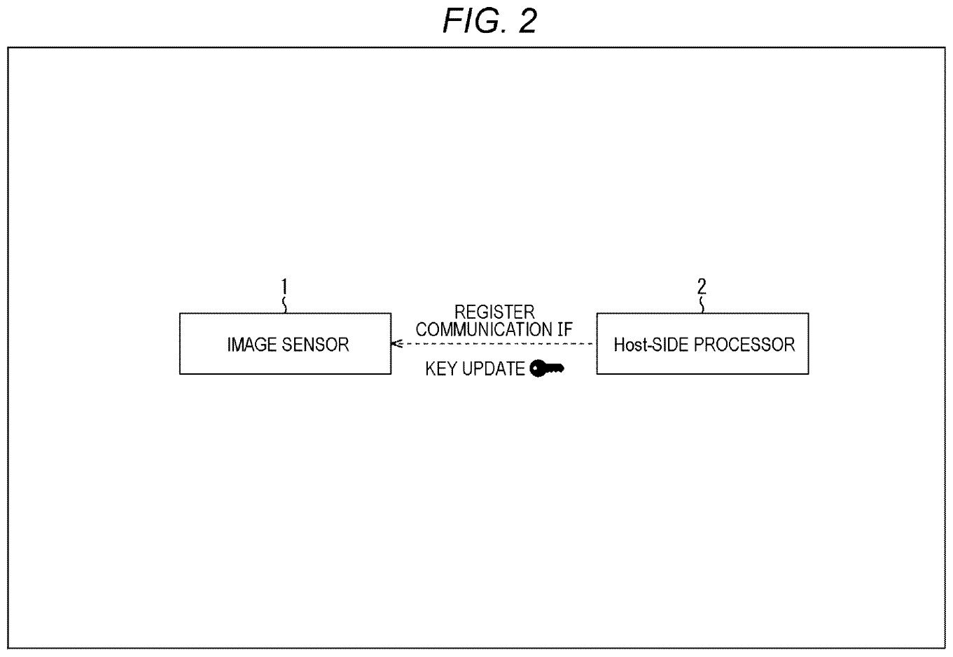

As illustrated in FIG. 2, in the communication System of FIG. 1, a key is updated by key distribution. The information transmitted from the Host-side processor 2 to the image sensor 1 at the time of key update includes information on a new key after the update. Key data itself such as common key data may be transmitted, or in a case where a plurality of keys is prepared in advance for each of the image sensor 1 and the Host-side processor 2, information specifying a new key may be transmitted.

The new key is transmitted using the register communication IF. The key used in the security processing for the image data transmitted using the high-speed communication IF is updated using the register communication IF which is a communication IF different from the high-speed communication IF. A flow of key update will be described later.

### High-Speed Communication IF

An SLVS-EC which is one of high-speed communication IFs will be described.

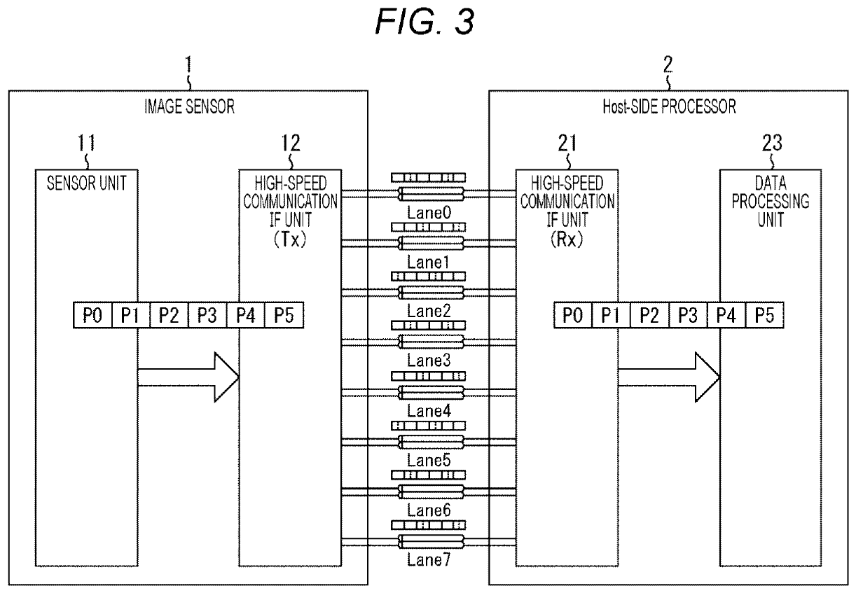

FIG. 3 is a diagram illustrating an example of data transmission by SLVS-EC. Note that FIG. 3 illustrates only the configuration related to the data transmission using the high-speed communication IF.

The sensor unit 11 of the image sensor 1 performs photoelectric conversion of light received via the lens. The sensor unit 11 performs A/D conversion and the like of a signal obtained by photoelectric conversion, and sequentially outputs pixel data constituting an image of one frame to the high-speed communication IF unit 12, for example, data of one pixel at a time. Security processing is appropriately performed on the data output from the sensor unit 11, and the data after the security processing is output to the high-speed communication IF unit 12.

The high-speed communication IF unit 12 allocates the data of each pixel output from the sensor unit 11 to a plurality of transmission paths and transmits the data to the Host-side processor 2 in parallel via the plurality of transmission paths. In the example of FIG. 3, pixel data is transmitted using eight transmission paths. The transmission path between the image sensor 1 and the Host-side processor 2 may be a wired transmission path or a wireless transmission path. Hereinafter, a transmission path between the image sensor 1 and the Host-side processor 2 is appropriately referred to as a lane.

The high-speed communication IF unit 21 of the Host-side processor 2 receives the pixel data transmitted from the high-speed communication IF unit 12 via eight lanes and sequentially outputs the data of each pixel to the data processing unit 23. As described above, data is transmitted and received using a plurality of lanes between the high-speed communication IF unit 12 and the high-speed communication IF unit 21.

The data processing unit 23 acquires image data of one frame on the basis of the pixel data supplied from the high-speed communication IF unit 21, and performs various types of image processing on the acquired image data. In the data processing unit 23, various types of processing such as compression of image data and recording of image data on a recording medium are performed.

In the SLVS-EC, an application layer (Application Layer), a link layer (LINK Layer), and a physical layer (PHY Layer) are defined according to the content of signal processing. The link layer processing and the physical layer processing are performed in each of the high-speed communication IF unit 12 and the high-speed communication IF unit 21.

As the processing of the link layer, for example, processing for realizing the following functions is performed.
1. Pixel Data to Byte Data Conversion
2. Error Correction of Payload Data
3. Transmission of Packet Data and Auxiliary Data
4. Error Correction of Payload Data Using Packet Footer
5. Lane Management
6. Protocol Management for Packet Generation

Meanwhile, as the processing of the physical layer, for example, processing for realizing the following functions is performed.
1. Generation and Extraction of Control Code
2. Control of Bandwidth
3. Control 4 skew Between Lanes
4. Placement of Symbols
5. Symbol Coding for Bit Synchronization
6. SERDES (SERializer/DESerializer)
7. Generation and Reproduction of Clock
8. Transmission of Scalable Low Voltage Signaling (SLVS) Signal

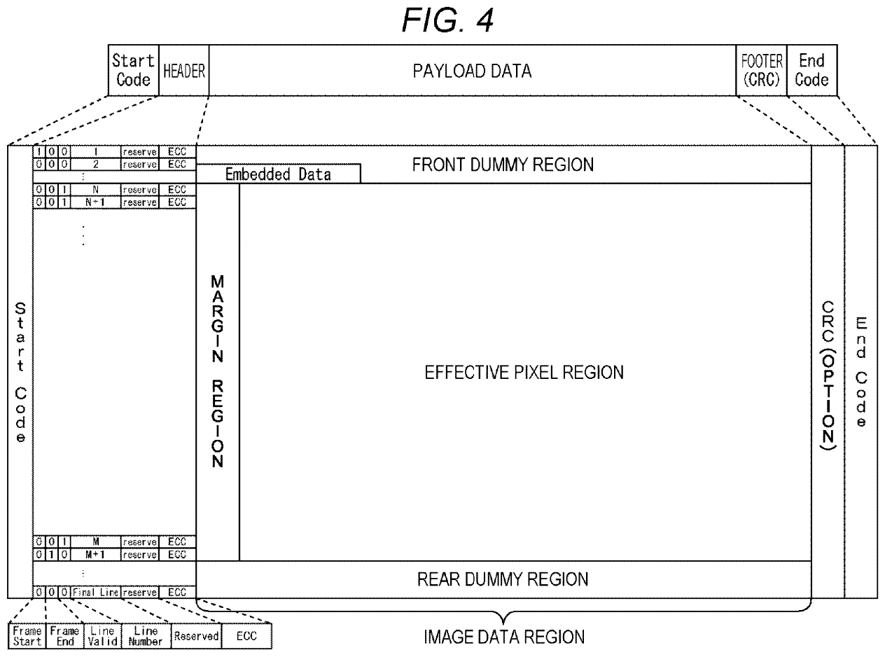

FIG. 4 is a diagram illustrating an example of a format used for data transmission of SLVS-EC.

The effective pixel region is a region of effective pixels of an image of one frame captured by the sensor unit 11. A margin region is arranged on the left side of the effective pixel region.

A front dummy region is arranged on the upper side of the effective pixel region. In the example of FIG. 4, Embedded Data is arranged in the front dummy region. Embedded Data includes information of setting values regarding imaging by the sensor unit 11, such as a shutter speed, an aperture value, and a gain. In addition to the information of the setting value related to imaging, various types of additional information such as Contents, format, and data size are appropriately arranged as Embedded Data. Embedded Data is additional information added to the image data of each frame.

A rear dummy region is disposed on the lower side of the effective pixel region. Embedded Data may be arranged in the rear dummy region.

The effective pixel region, the margin region, the front dummy region, and the rear dummy region constitute an image data region.

A header is added before each line constituting the image data region, and Start Code is added before the header. Further, a footer is optionally added after each line constituting the image data region, and a control code such as End Code is added after the footer. In a case where no footer is added, a control code such as End Code is added after each line constituting the image data region.

Data transmission is performed using frame data in the format illustrated in FIG. 4 for each image of one frame captured by the sensor unit 11.

An upper band in FIG. 4 illustrates a structure of a packet used for transmission of the frame data illustrated on the lower side. Assuming that the arrangement of data in the horizontal direction is a line, data constituting one line of the image data region is stored in the payload of the packet. The entire frame data of one frame is transmitted using a number of packets equal to or larger than the number of pixels in the vertical direction of the image data region. Furthermore, transmission of the entire frame data of one frame is performed, for example, by transmitting a packet storing data in units of lines in order from data arranged in the upper line.

One packet is configured by adding a header and a footer to a payload in which data for one line is stored. At least Start Code and End Code which are control codes are added to each packet.

As illustrated in the lower left of FIG. 4, the header includes additional information of data stored in the payload, such as Frame Start, Frame End, Line Valid, and Line Number.

Frame Start is 1-bit information indicating the head of the frame. A value of 1 is set to Frame Start of a header of a packet used for transmission of data of the first line of frame data, and a value of 0 is set to Frame Start of a header of a packet used for transmission of data of another line.

The Frame End is 1-bit information indicating the end of the frame. A value of 1 is set to Frame End of a header of a packet including data of an end line of frame data, and a value of 0 is set to Frame End of a header of a packet used for transmission of data of another line.

The Line Valid is 1-bit information indicating whether or not a line of data stored in the packet is a line of the effective pixel region. A value of 1 is set to Line Valid of a header of a packet used for transmission of pixel data of a line in the effective pixel region, and a value of 0 is set to Line Valid of a header of a packet used for transmission of data of another line.

The Line Number is 13-bit information indicating a line number of a line in which data stored in a packet is arranged.

Even in a case where the high-speed communication IF unit 12 of the image sensor 1 and the high-speed communication IF unit 21 of the Host-side processor 2 are high-speed communication IFs compatible with a standard different from the SLVS-EC, frame data in which image data of each frame is arranged is generated, and data transmission is performed using a packet storing data of each line of the frame data.

### Flow of Key Update

A basic flow of key update realized by key distribution will be described.

### Flow in Case Where Update Processing is in Time for Switching Timing of Frame Data

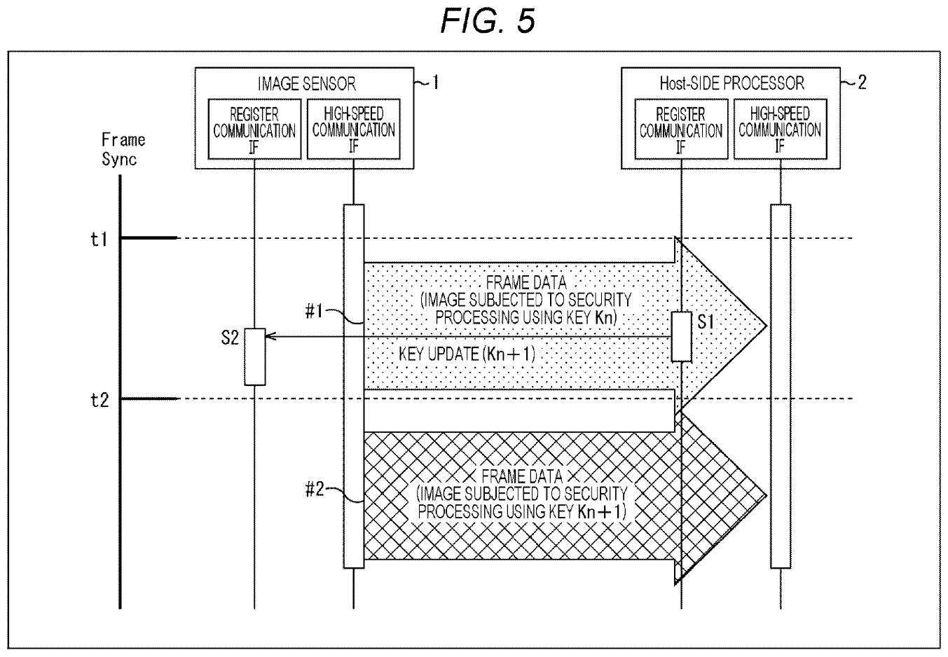

A flow of key update will be described with reference to the sequence of FIG. 5.

It is assumed that a key Kn is set as a key before updating. In this case, as indicated by an arrow #1 in FIG. 5, frame data including image data subjected to security processing using the key Kn is transmitted from the image sensor 1 to the Host-side processor 2 using the high-speed communication IF. As described above, by sequentially transmitting the packets storing the data of each line, the frame data including the image data subjected to the security processing using the key Kn is transmitted.

As illustrated on the left side of FIG. 5, the transmission timing of each frame data is defined by a synchronization signal generated in the image sensor 1. In the example of FIG. 5, the transmission of the frame data of the first frame including the image data subjected to the security processing using the key Kn is started at time t1.

The Host-side processor 2 that has received the packet storing the data of each line constituting the frame data of the first frame performs decryption processing using the key Kn to acquire image data which is output data of the image sensor 1.

In a case where the key update timing is reached during transmission and reception of the frame data of the first frame, the Host-side processor 2 performs key update using the register communication IF in step S1. The information transmitted to the image sensor 1 includes information of a key Kn+1 that is a new key.

In step S2, the image sensor 1 receives information transmitted from the Host-side processor 2. The image sensor 1 performs update processing such as rewriting a value of a register. The update processing performed here is processing for updating the key for the high-speed communication IF from the key Kn to the key Kn+1.

At time t2 after completion of the update processing, the image sensor 1 switches the key used for the security processing to the key Kn+1, and starts transmission of the frame data of the second frame as indicated by an arrow #2. The frame data of the second frame includes image data subjected to security processing using the key Kn+1.

The Host-side processor 2 that has received the packet storing the data of each line constituting the frame data of the second frame performs the security processing using the key Kn+1 and acquires image data which is output data of the image sensor 1. In the Host-side processor 2, which key is used for the security processing is managed.

The high-speed communication IF and the register communication IF are independently operable communication IFs. The image sensor 1 and the Host-side processor 2 can perform key update using the register communication IF during the security operation of the high-speed communication IF.

As described above, since the security processing using the key is performed on the image data in units of frames, the key switching timing reflecting the key update by the Host-side processor 2 is the frame data switching timing.

In a case where key update occurs during transmission and reception of certain frame data, and the key update processing in the image sensor 1 is in time for the timing of starting transmission of the next frame data, a new key is used from the next frame data.

### Flow in Case Where Update Processing Is Not in Time for Switching Timing of Frame Data

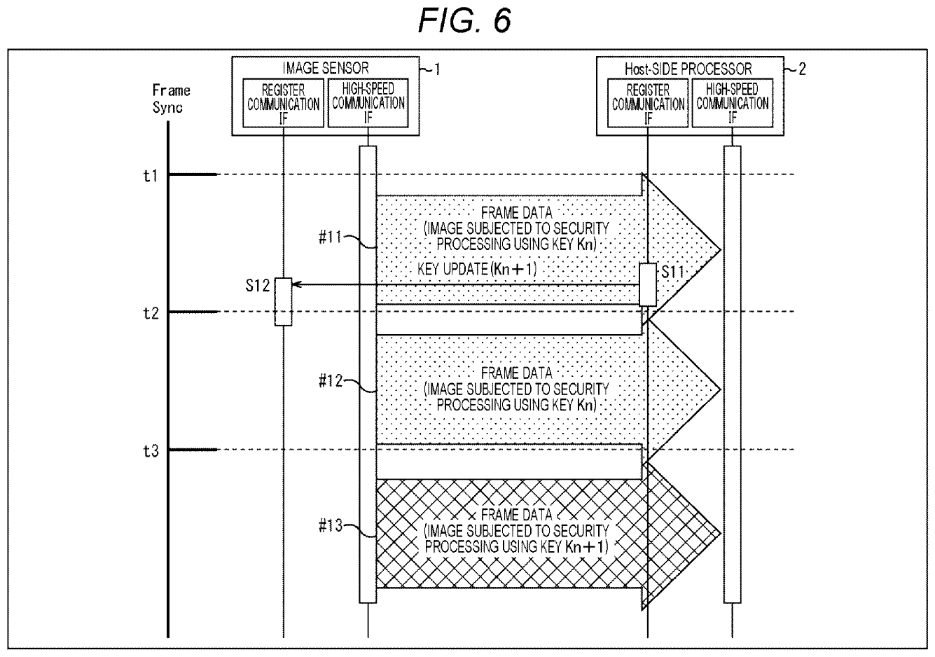

Another flow of key update will be described with reference to the sequence of FIG. 6.

Also in FIG. 6, it is assumed that a key Kn is set as a key before updating. As indicated by an arrow #11 in FIG. 6, frame data including image data subjected to security processing using the key Kn is transmitted from the image sensor 1 to the Host-side processor 2 using the high-speed communication IF.

The Host-side processor 2 that has received the packet storing the data of each line constituting the frame data of the first frame performs the security processing using the key Kn and acquires image data which is output data of the image sensor 1.

In a case where the key update timing is reached during transmission and reception of the frame data of the first frame, the Host-side processor 2 performs key update using the register communication IF in step S11. The information transmitted to the image sensor 1 includes information of a key Kn+1 that is a new key.

In step S12, the image sensor 1 receives information transmitted from the Host-side processor 2 and performs update processing. The update processing performed here is processing for updating the key for the high-speed communication IF from the key Kn to the key Kn+1.

In the example of FIG. 6, the key update processing is continued until and after time t2 which is the timing of starting transmission of the frame data of the second frame. In a case where the key update processing has not been completed by the time t2, the key Kn is used to transmit the frame data of the second frame as indicated by an arrow #12.

At time t3, the image sensor 1 switches the key used for the security processing to the key Kn+1, and starts transmitting the frame data of the third frame as indicated by an arrow #13. The key Kn+1, which is a new key, is used from the frame data of the third frame.

As described above, depending on the processing capability of the image sensor 1 or the like, the key update processing may not be in time for the timing of starting transmission of the next frame data. That is, there may be a difference between the timing at which the Host-side processor 2 performs the key update by transmitting the information of the new key and the timing at which the key is switched by being reflected in the image sensor 1.

In a case where the Host-side processor 2 updates the key by transmitting the information of the new key, it is necessary to grasp which key is used in the image sensor 1 to transmit the frame data by the high-speed communication IF. For example, the Host-side processor 2 needs to grasp that the key Kn is used for the frame data of the second frame to start transmission at time t2. In addition, the Host-side processor 2 needs to grasp that the key Kn+1 is used for the frame data of the third frame to start transmission at time t3.

In the communication system of FIG. 1, a key ID that is identification information of each key is used so that the Host-side processor 2 can grasp which key is used for security processing.

### Processing Using Key ID

### Transmission Example of Key ID

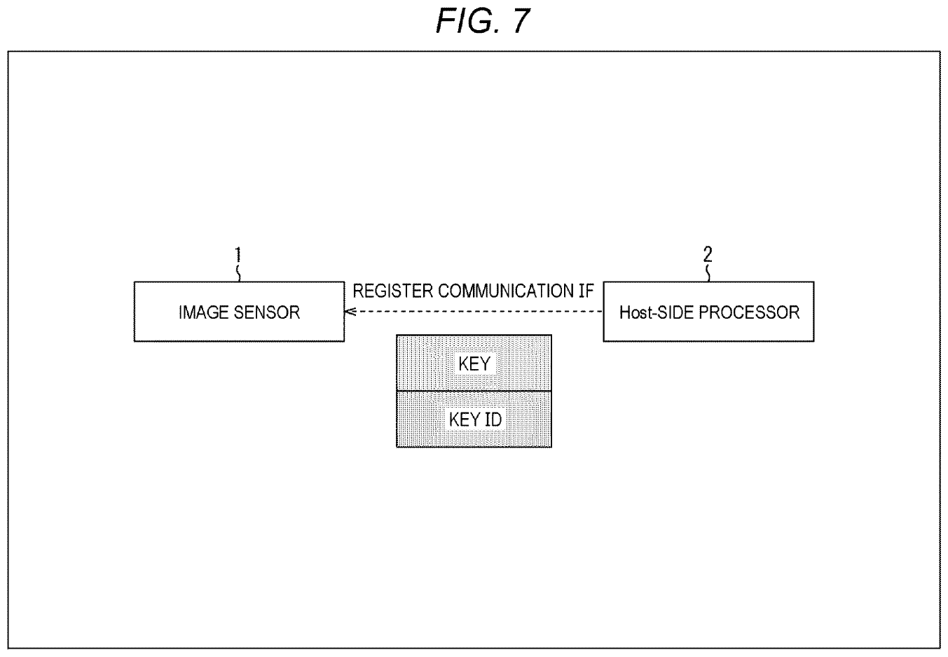

FIG. 7 is a diagram illustrating an example of information transmitted at the time of key update.

At the time of key update, as illustrated in FIG. 7, a set of a key and a key ID which is identification information of the key is transmitted as key update information from the Host-side processor 2 to the image sensor 1 using the register communication IF. The key included in the key update information is a new key for the high-speed communication IF.

Security processing such as encryption or addition of a MAC value is appropriately performed on the key and the key ID. The key used for the security processing of the key and the key ID is a key for the register communication IF different from the key for the high-speed communication IF. The image sensor 1 and the Host-side processor 2 have the key for the register communication IF.

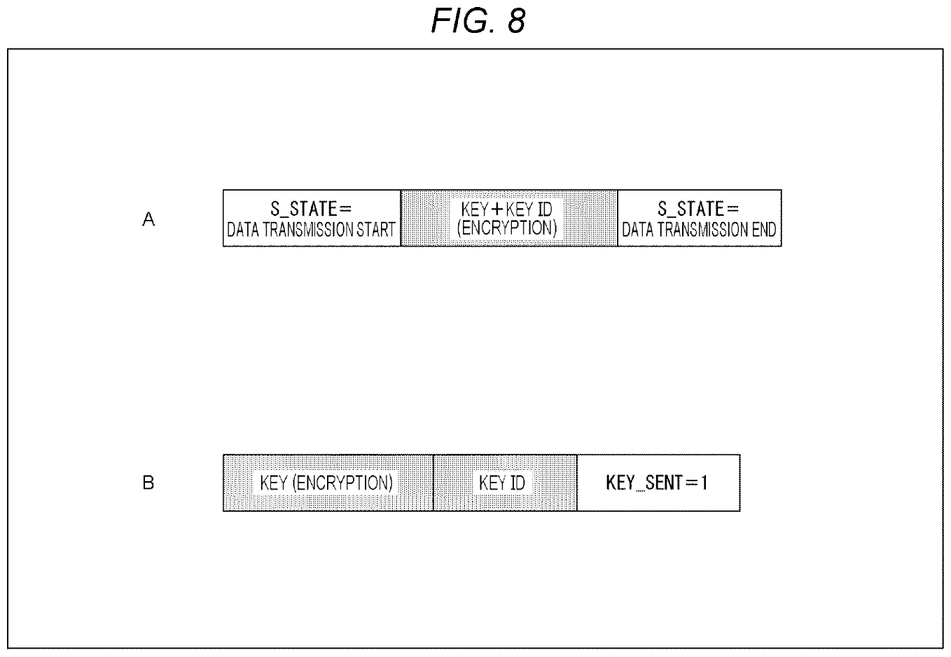

FIG. 8 is a diagram illustrating an example of a data structure of key update information.

### Transmission Example 1

As illustrated in A of FIG. 8, key update information is transmitted by adding a flag indicating start of data transmission and a flag indicating end of data transmission before and after the flag. In the example in A of FIG. 8, the key for the high-speed communication IF and the key ID are encrypted using the key for the register communication IF, and the key update information is configured by the encrypted data.

In the register of the image sensor 1, a region for a flag S_STATE, which is a flag indicating start/end of data transmission, is secured. In the image sensor 1, after the value indicating the start of data transmission is written as the value of the flag S_STATE, decryption processing for the transmitted data is performed using the key for the register communication IF, and a new key and a key ID are acquired. After the new key and the key ID are acquired, a value indicating the end of data transmission is written as the value of the flag S_STATE.

The key update using the key update information illustrated in A of FIG. 8 is performed, for example, in a case where a region for the flag S_STATE is secured in the register of the image sensor 1.

### Transmission Example 2

As illustrated in B of FIG. 8, the key update information is transmitted by adding a flag KEY_SENT notifying that the new key has been transmitted to the back. In the example of B of FIG. 8, the key for the high-speed communication IF is encrypted using the key for the register communication IF, and the key update information is configured by adding the key ID to the encrypted data. The key ID may be encrypted together with the key.

In the image sensor 1, decryption processing is performed using a key for the register communication IF, and a new key and a key ID for the high-speed communication IF are acquired. In addition, after the new key and the key ID are acquired, the value 1 is written as the value of the flag KEY_SENT. For example, a value of the flag S_STATE of 1 indicates that a new key has been transmitted.

The key update using the key update information illustrated in B of FIG. 8 is performed, for example, in a case where a region for the flag KEY_SENT is secured in the register of the image sensor 1. After the value 1 is set as the value of the flag S_STATE, the value 0 is written by the image sensor 1 as the value of the flag S_STATE.

The value 0 may be written to the flag S_STATE by the Host-side processor 2 that has confirmed that the key update has been reflected (that the key has been switched to the new key) on the basis of the key ID. By updating the value of the flag S_STATE in the register by toggling or by incrementing, it may be notified that a new key has been transmitted.

In this manner, at least the new key is encrypted, and is included in the key update information together with the key ID and transmitted to the image sensor 1.

### Transmission Example 3

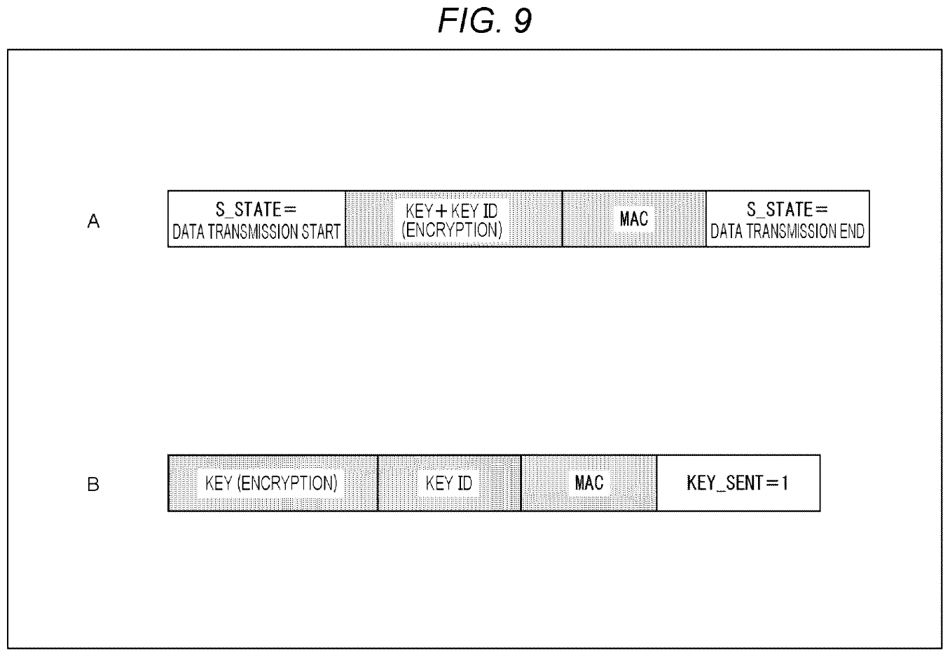

As illustrated in A of FIG. 9, a MAC value may be added to key update information including encrypted data of a key and a key ID. The data structure illustrated in A of FIG. 9 is different from the data structure in A of FIG. 8 in that a MAC value is added after key update information. The MAC value added to the key update information is, for example, information generated by a MAC operation on encrypted data of a key and a key ID.

The image sensor 1 performs a MAC operation on the encrypted data transmitted from the Host-side processor 2 to obtain a MAC value. Furthermore, tamper detection is performed by collating the MAC value obtained by the MAC operation with the MAC value added to the encrypted data.

### Transmission Example 4

As illustrated in B of FIG. 9, a MAC value may be added after the key ID. The data structure illustrated in B of FIG. 9 is different from the data structure in B of FIG. 8 in that a MAC value is added after the key ID. The MAC value added after the key ID is, for example, information generated by a MAC operation on the encrypted data of the key and the key ID.

In the image sensor 1, a MAC operation is performed on the encrypted data and the key ID transmitted from the Host-side processor 2 to obtain a MAC value. Furthermore, tamper detection is performed by collating the MAC value obtained by the MAC operation with the MAC value added after the key ID.

In this manner, it is possible to perform tamper detection using the MAC value at the time of key update. The MAC value may be transmitted separately from the set of the key and the key ID.

### Flow of Key Update Using Key Update Information

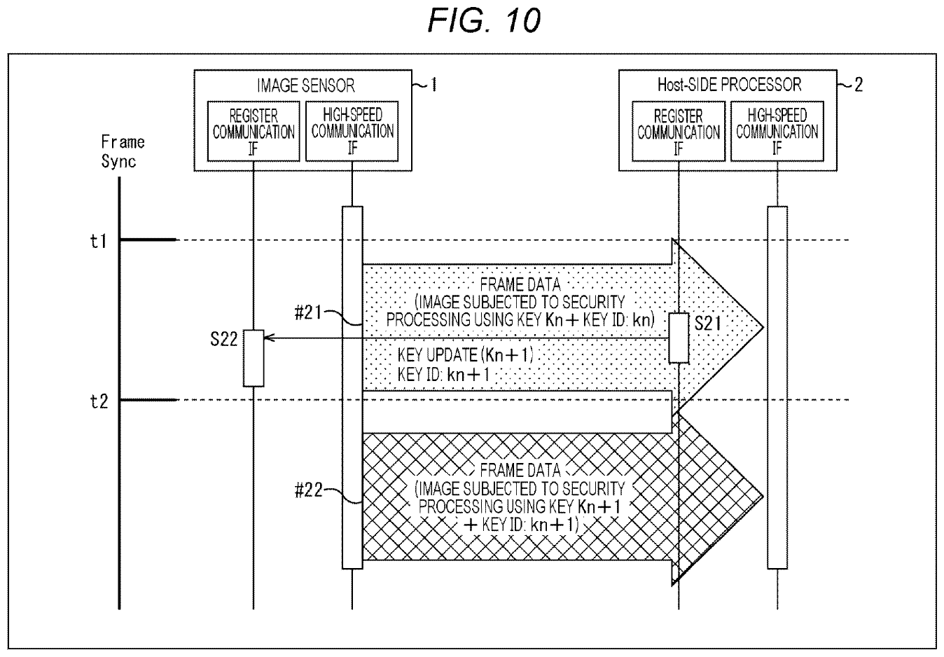

A flow of key update using key update information will be described with reference to the sequence of FIG. 10.

It is assumed that a key Kn is set as a key before updating. In addition, it is assumed that a key IDkn which is a key ID of the key Kn is managed in each of the image sensor 1 and the Host-side processor 2. The key ID indicates that the key identified by the key ID is used for security processing as a key for the high-speed communication IF.

In this case, as indicated by an arrow #21 in FIG. 10, frame data including image data subjected to security processing using the key Kn is transmitted from the image sensor 1 to the Host-side processor 2 using the high-speed communication IF. A key IDkn is arranged at a predetermined position of the frame data of the first frame.

The Host-side processor 2 that has received the packet storing the data of each line constituting the frame data of the first frame confirms that the key used for the security processing of the image data included in the frame data of the first frame is the key Kn on the basis of the key IDkn arranged in the frame data. The Host-side processor 2 performs decryption processing using the key Kn and acquires image data which is output data of the image sensor 1.

In a case where the key update timing is reached during transmission and reception of the frame data of the first frame, the Host-side processor 2 performs key update using the register communication IF in step S21. The key update information transmitted to the image sensor 1 includes a set of a key Kn+1 that is a new key and a key IDkn+1 that is a key ID of the key Kn+1. The key update information is transmitted as described with reference to FIGS. 8 and 9.

In step S22, the image sensor 1 receives the key update information transmitted from the Host-side processor 2. The image sensor 1 performs update processing such as decrypting the encrypted key and rewriting the value of the register. The update processing performed here is processing for updating the key for the high-speed communication IF from the key Kn to the key Kn+1.

At time t2 after completion of the update processing, the image sensor 1 switches the key used for the security processing to the key Kn+1, and starts transmitting the frame data of the second frame as indicated by an arrow #22. The frame data of the second frame includes image data subjected to security processing using the key Kn+1. In addition, a key IDkn+1, which is a key ID of the key Kn+1, is arranged at a predetermined position of the frame data of the second frame.

The Host-side processor 2 that has received the packet storing the data of each line constituting the frame data of the second frame confirms that the key used for the security processing of the image data included in the frame data of the second frame is the key Kn+1 on the basis of the key IDkn+1 arranged in the frame data. The Host-side processor 2 performs decryption processing using the key Kn+1 and acquires image data which is output data of the image sensor 1.

As described above, when the key is updated, the key ID which is identification information associated with the key is transmitted from the Host-side processor 2 to the image sensor 1. In addition, in the frame data transmitted after the key for the high-speed communication IF is switched in the image sensor 1, a key ID indicating which key is used for the security processing of the frame data is arranged.

The image sensor 1 can notify the Host-side processor 2 of which key is used for the security processing by transmitting the frame data in which the key ID is arranged. The Host-side processor 2 can confirm a key switching timing used for the security processing on the basis of the key ID included in the frame data.

### Arrangement Example of Key ID

### Arrangement Example 1

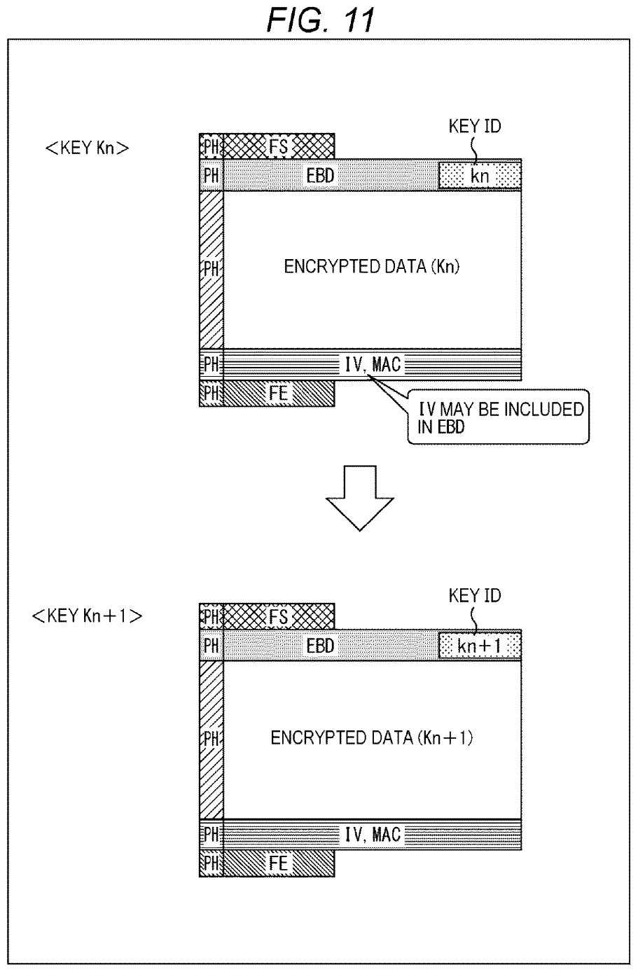

FIG. 11 is a diagram illustrating an arrangement example of key IDs.

In the frame data illustrated in FIG. 11, the key ID is arranged to be included in an Embedded Data (EBD) arranged in a line before the encrypted data. The encrypted data arranged in the frame data illustrated in FIG. 11 is image data encrypted using the key for the high-speed communication IF.

As illustrated in the upper part of FIG. 11, the key IDkn is included in the EBD of the frame data including the image data encrypted using the key Kn.

In a case where the key for the high-speed communication IF is switched from the key Kn to the key Kn+1, as illustrated in the lower part of FIG. 11, the EBD of the frame data including the image data encrypted using the key Kn+1 includes the key IDkn+1.

The Host-side processor 2 that has received the frame data as illustrated in FIG. 11 can confirm the timing at which the key is switched in the image sensor 1 on the basis of the key ID included in the EBD. In this manner, the key ID can be arranged as information constituting the EBD which is additional information.

Note that a Frame Start (FS) line and a Frame End (FE) line are arranged at the head and the end of the frame data, respectively. The Frame Start line is a line of data in which a value of 1 is set to Frame Start of the packet header. Furthermore, the Frame End line is a line of data in which a value of 1 is set to Frame End of the packet header. In FIG. 11, the packet header is indicated as “PH”.

In the example of FIG. 11, the information of the IV and the information of the MAC value are arranged in the next line of the encrypted data of one frame which is the data of the plurality of lines. The IV is an encryption parameter used together with a key for encryption of image data. The MAC value is information used for tamper detection of image data. In a case where the mode of the security operation in the image sensor 1 and the Host-side processor 2 is a mode of performing encryption and tamper detection using a MAC value, the information of the IV and the information of the MAC value are arranged in the frame data. The information of the IV may be included in the EBD.

### Arrangement Example 2

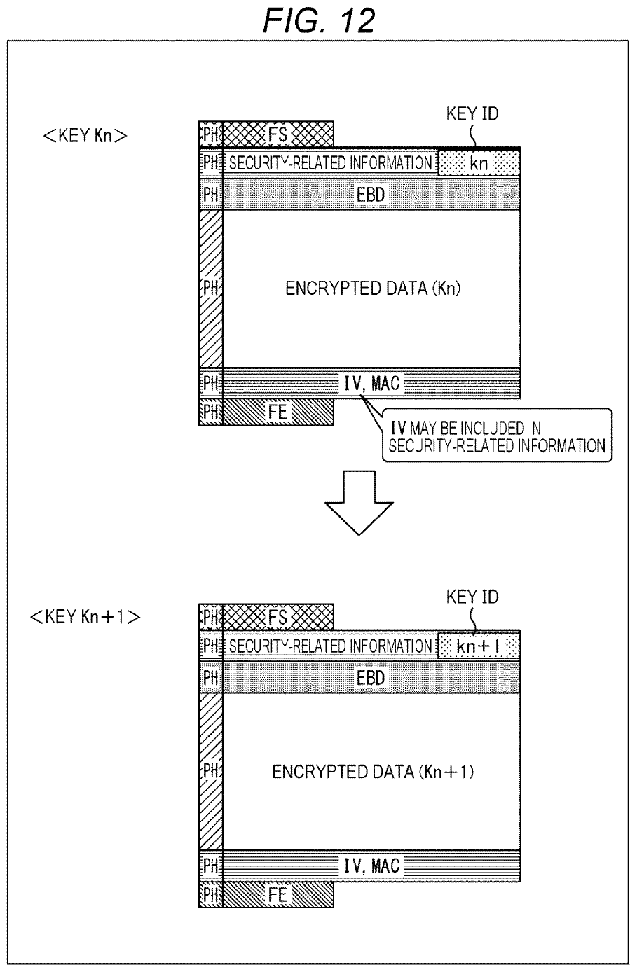

FIG. 12 is a diagram illustrating another arrangement example of the key IDs. The description overlapping with the description of FIG. 11 will be appropriately omitted.

In the frame data illustrated in FIG. 12, the line of the security-related information is arranged before the line of the EBD. A key ID is arranged as information constituting the security-related information.

The security-related information is information used to implement security of output data. The security information includes, for example, the following information in addition to the key ID.
Security Error/Warning Information of Register Communication
Information Indicating Detection of Attack Inside Sensor
Information for Security Error/Warning Analysis
Internal State Information
Operation Mode Related Information
Information for Notifying That Register Communication Has Occurred
Frame Counter
Information About Data Size of One Frame As illustrated in the upper part of FIG. 12, the key IDkn is included in the security-related information of the frame data including the image data encrypted using the key Kn.

In a case where the key for the high-speed communication IF is switched from the key Kn to the key Kn+1, as illustrated in the lower part of FIG. 12, the key IDkn+1 is included in the security-related information of the frame data including the image data encrypted using the key Kn+1.

The Host-side processor 2 that has received the frame data as illustrated in FIG. 12 can check the timing at which the key is switched in the image sensor 1 on the basis of the key ID included in the security-related information. Information of the IV may be included in the security-related information.

### Arrangement Example 3

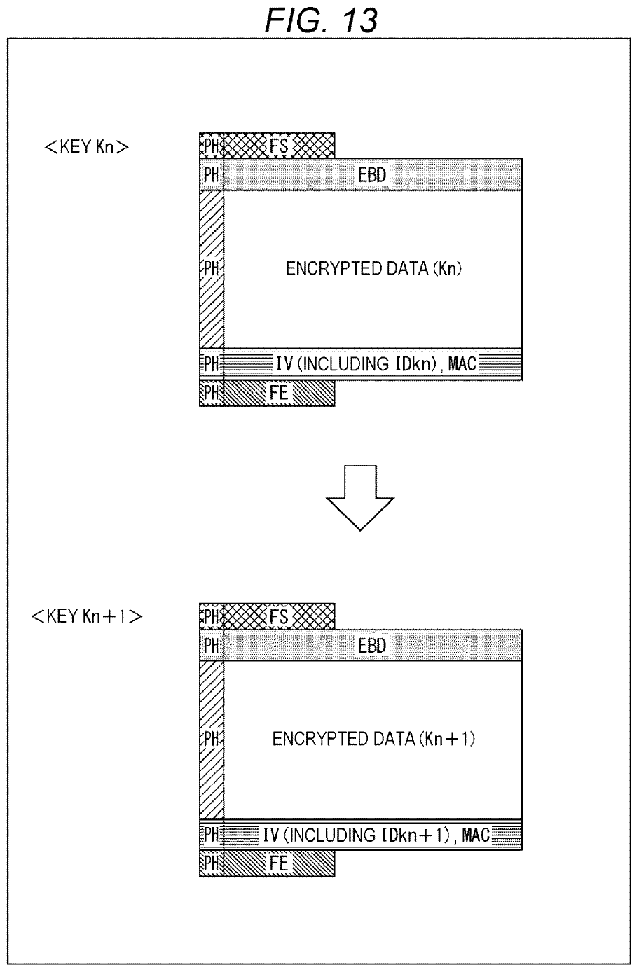

FIG. 13 is a diagram illustrating another arrangement example of the key IDs.

In the frame data illustrated in FIG. 13, a key ID is arranged as information constituting a part of an initial vector (IV) arranged in the next line of encrypted data.

As illustrated in the upper part of FIG. 13, the key IDkn is included in the information of the IV of the frame data including the image data encrypted using the key Kn.

In a case where the key for the high-speed communication IF is switched from the key Kn to the key Kn+1, as illustrated in the lower part of FIG. 13, the key IDkn+1 is included in the information of the IV of the frame data including the image data encrypted using the key Kn+1.

The Host-side processor 2 that has received the frame data as illustrated in FIG. 13 can confirm the timing at which the key is switched in the image sensor 1 on the basis of the key ID included in the IV. In this manner, the key ID can be arranged at various positions of the frame data.

### Application Example to Multi-sensor System

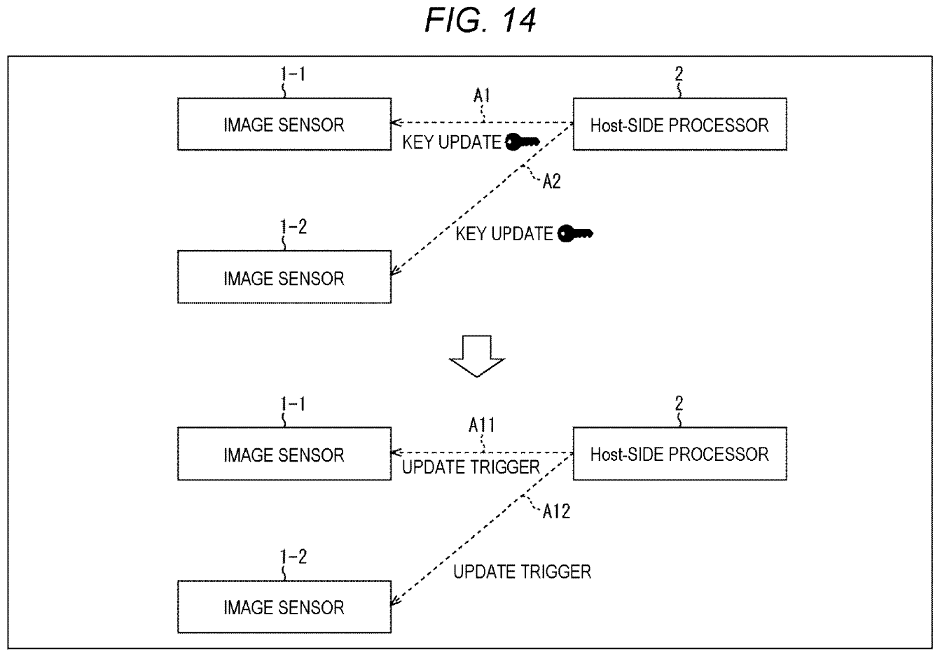

FIG. 14 is a diagram illustrating another configuration example of the communication system according to an embodiment of the present technology.

The communication system of FIG. 14 is configured by connecting an image sensor 1-1 and an image sensor 1-2, which are two image sensors, to the Host-side processor 2. A larger number of image sensors may be connected to the Host-side processor 2. The communication system illustrated in FIG. 14 is a multi-sensor system in which a plurality of image sensors is connected to one Host.

The image sensor 1-1 and the image sensor 1-2 have the same function. In a case where it is not necessary to distinguish the image sensor 1-1 and the image sensor 1-2 from each other, they are collectively referred to as an image sensor 1.

As a key for the high-speed communication IF, the same key is used in image sensor 1-1 and image sensor 1-2. In the Host-side processor 2, since the security processing is performed on the frame data transmitted from all the image sensors 1 using the same key, it is necessary to match the key switching timing in the image sensor 1-1 with the key switching timing in the image sensor 1-2.

At the time of key update, as indicated by arrows A1 and 2 in the upper part of FIG. 14, the Host-side processor 2 transmits key update information including a set of a new key and a key ID to the image sensor 1-1, and then transmits key update information including the same set of the new key and the key ID to the image sensor 1-2. As described above, in the key update of the multi-sensor system, the key update information is sequentially transmitted to each image sensor.

In a case where the transmission of the key update information to all the image sensors is completed, as indicated by arrows All and 12 in the lower part of FIG. 14, the Host-side processor 2 transmits an update trigger to each of the image sensor 1-1 and the image sensor 1-2 using the register communication IF. The update trigger is information indicating that the transmission of the new key to all the image sensors has been completed.

Each of the image sensor 1-1 and the image sensor 1-2 that have received the update trigger switches the key for the high-speed communication IF to a new key, and starts transmission of image data subjected to security processing using the new key and frame data in which a key ID of the new key is arranged. In response to the transmission of the update trigger, the key update is reflected in each of image sensor 1-1 and image sensor 1-2.

As described above, the new key is previously transmitted to all the image sensors 1, and the update trigger is transmitted at the timing when the key update processing is completed in all the image sensors 1, whereby the key switching timing is notified. As a result, it is possible to match key switching timings in the respective image sensors 1.

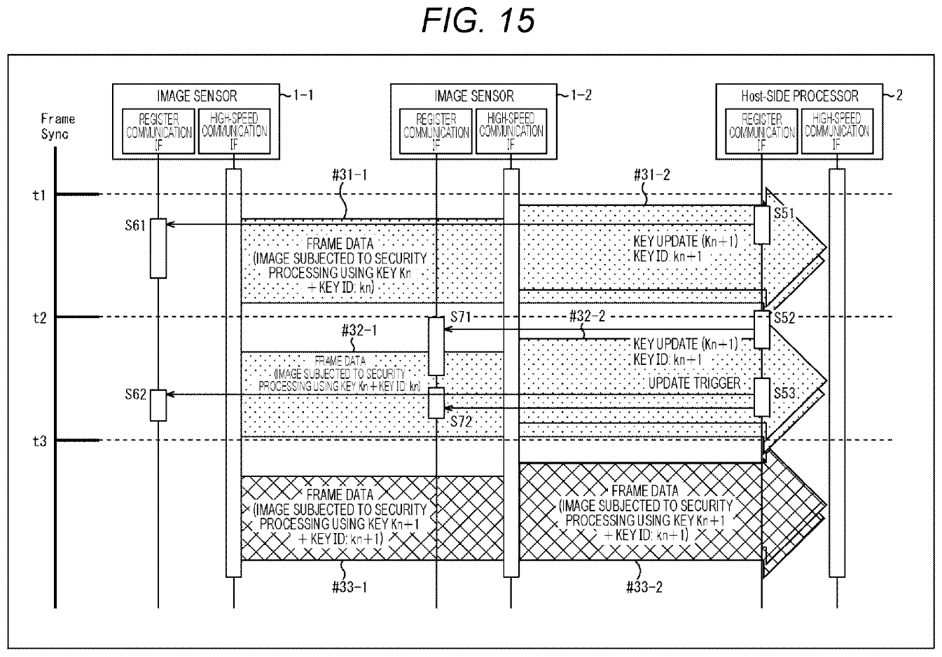

A flow of key update in a multi-sensor system will be described with reference to the sequence of FIG. 15.

It is assumed that a key Kn is set as a key before updating. Further, it is assumed that the key ID of the key Kn is managed in each of the image sensors 1-1 and 1-2 and the Host-side processor 2.

In this case, as indicated by an arrow #31-1 in FIG. 15, frame data including image data subjected to security processing using the key Kn is transmitted from the image sensor 1-1 to the Host-side processor 2 using the high-speed communication IF. A key IDkn is arranged at a predetermined position of the frame data of the first frame transmitted by the image sensor 1-1.

In addition, as indicated by an arrow #31-2, frame data including image data subjected to security processing using the key Kn is transmitted from the image sensor 1-2 to the Host-side processor 2 using the high-speed communication IF. A key IDkn is arranged at a predetermined position of the frame data of the first frame transmitted by the image sensor 1-2.

The Host-side processor 2 that has received the packet transmitted from the image sensor 1-1 confirms that the key used for the security processing of the image data included in the frame data of the first frame is the key Kn on the basis of the key IDkn arranged in the frame data. The Host-side processor 2 performs decryption processing using the key Kn and acquires image data which is output data of the image sensor 1-1.

Similarly, the Host-side processor 2 that has received the packet transmitted from the image sensor 1-2 confirms that the key used for the security processing of the image data included in the frame data of the first frame is the key Kn on the basis of the key IDkn arranged in the frame data. The Host-side processor 2 performs decryption processing using the key Kn and acquires image data which is output data of the image sensor 1-2.

In this example, the transmission of the frame data of the first frame by the image sensor 1-1 and the transmission of the frame data of the first frame by the image sensor 1-2 are performed between the time t1 and the time t2 according to the same synchronization signal.

In a case where the key update timing is reached during transmission and reception of the frame data of the first frame, the Host-side processor 2 updates the key for the image sensor 1-1 in step S51. The key update information transmitted to the image sensor 1-1 includes a set of a key Kn+1 that is a new key and a key IDkn+1 that is a key ID of the key Kn+1.

In step S61, the image sensor 1-1 receives the key update information transmitted from the Host-side processor 2, and performs update processing such as decrypting the encrypted key and rewriting the value of the register. The update processing performed here is processing for updating the key for the high-speed communication IF from the key Kn to the key Kn+1.

In step S52 after the key update for the image sensor 1-1, the Host-side processor 2 updates the key for the image sensor 1-2. The key update information transmitted to the image sensor 1-2 includes a set of a key Kn+1 that is a new key and a key IDkn+1 that is a key ID of the key Kn+1. As described above, a time difference may occur in the key update for each of the image sensors 1 depending on the processing status of the Host-side processor 2 or the like.

In step S71, the image sensor 1-2 receives the key update information transmitted from the Host-side processor 2, and performs update processing such as decrypting the encrypted key and rewriting the value of the register. The update processing performed here is processing for updating the key for the high-speed communication IF from the key Kn to the key Kn+1.

In this example, the key update is not reflected until an update trigger is transmitted. As indicated by an arrow #32-1, the key Kn is also used to transmit the frame data of the second frame in the image sensor 1-1 in which the update processing is completed by the time t2 that is the timing of switching the frame data.

As indicated by an arrow #32-2, the key Kn is also used to transmit the frame data of the second frame in the image sensor 1-2.

In step S53 after the key update for the image sensor 1-2, the Host-side processor 2 sequentially transmits an update trigger to the image sensor 1-1 and the image sensor 1-2.

In step S62, the image sensor 1-1 receives the update trigger and reflects the key update by switching the key for the high-speed communication IF from the key Kn to the key Kn+1.

Furthermore, in step S72, the image sensor 1-2 receives the update trigger and reflects the key update by switching the key for the high-speed communication IF from the key Kn to the key Kn+1.

At time t3 which is the timing of switching the frame data, transmission of the frame data of the third frame including the image data subjected to the security processing using the key Kn+1 is started.

As indicated by an arrow #33-1, frame data including image data subjected to security processing using the key Kn+1 is transmitted from the image sensor 1-1 to the Host-side processor 2 using the high-speed communication IF. A key IDkn+1, which is a key ID of the key Kn+1, is arranged at a predetermined position of the frame data of the third frame.

In addition, as indicated by an arrow #33-2, frame data including image data subjected to security processing using the key Kn+1 is transmitted from the image sensor 1-2 to the Host-side processor 2 using the high-speed communication IF. A key IDkn+1, which is a key ID of the key Kn+1, is arranged at a predetermined position of the frame data of the third frame.

The Host-side processor 2 that has received the packet transmitted from the image sensor 1-1 confirms that the key used for the security processing of the image data included in the frame data of the third frame is the key Kn+1 on the basis of the key IDkn+1 arranged in the frame data. The Host-side processor 2 performs decryption processing using the key Kn+1 and acquires image data which is output data of the image sensor 1-1.

Similarly, the Host-side processor 2 that has received the packet transmitted from the image sensor 1-2 confirms that the key used for the security processing of the image data included in the frame data of the third frame is the key Kn+1 on the basis of the key IDkn+1 arranged in the frame data. The Host-side processor 2 performs decryption processing using the key Kn+1 and acquires image data which is output data of the image sensor 1-2.

As described above, the switching of the key for the high-speed communication IF in each image sensor 1 can be performed in response to the update trigger being transmitted from the Host-side processor 2. As a result, it is possible to match switching timings of keys used in the respective image sensors 1 constituting the multi-sensor system. In a case where the same key is sent to a plurality of image sensors, a plurality of values may be set as the value of the ID indicating the key Kn that is the same key, and key IDs having different values may be used for each sensor, such as the key IDkn and the key IDkn'.

### Configuration of Each Apparatus

Here, configurations of the image sensor 1 and the Host-side processor 2 having the above-described functions will be described.

### Configuration of Image Sensor 1

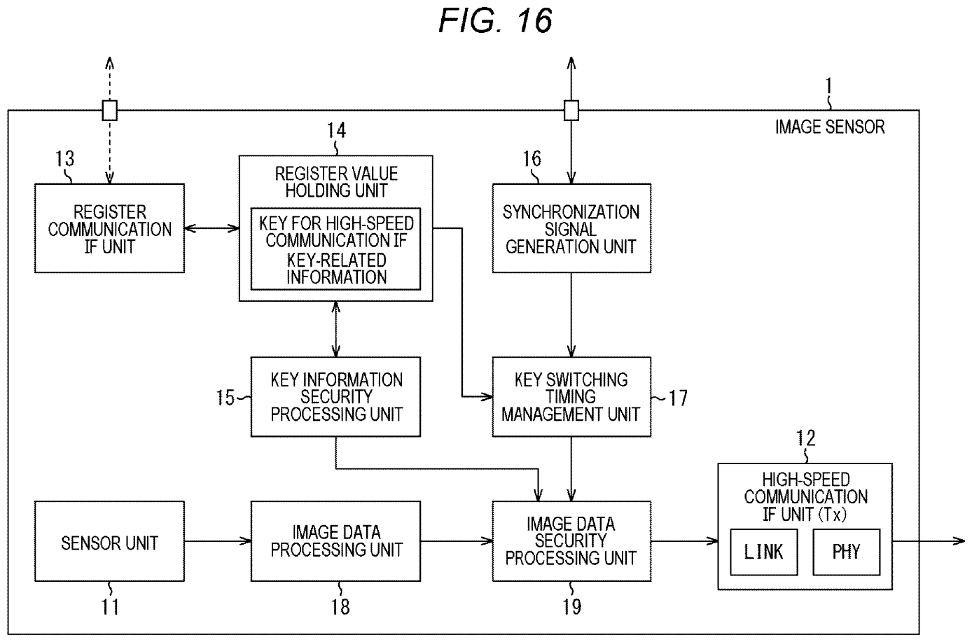

FIG. 16 is a block diagram illustrating a configuration example of the image sensor 1. In the configuration illustrated in FIG. 16, the same components as those described above are denoted by the same reference signs. Overlapping description will be omitted as appropriate.

In addition to the sensor unit 11, the high-speed communication IF unit 12, and the register communication IF unit 13, the image sensor 1 is provided with a register value holding unit 14, a key information security processing unit 15, a synchronization signal generation unit 16, a key switching timing management unit 17, an image data processing unit 18, and an image data security processing unit 19.

The register communication IF unit 13 performs register communication with the register communication IF unit 22 of the Host-side processor 2 and transmits and receives various data. For example, the register communication IF unit 13 receives the key update information transmitted from the register communication IF unit 22. The register communication IF unit 13 functions as a first communication unit that performs communication using the register communication IF with the Host-side processor 2 which is an apparatus serving as a transmission destination of the output data. The reception of the key update information in step S22 in FIG. 10, step S61 in FIG. 15, and the like is processing performed by the register communication IF unit 13.

The register value holding unit 14 is a register that stores various data on the basis of a command from the Host-side processor 2 received by the register communication IF unit 13. In the register value holding unit 14, a key region for high-speed communication IF and a key-related information region are secured. The key-related information includes a key ID, various flags, and an update trigger.

The data stored in the register value holding unit 14 is read by the key information security processing unit 15 and the key switching timing management unit 17 as appropriate, and is transmitted to the Host-side processor 2 in response to reception of the Read command in the register communication IF unit 13.

The key information security processing unit 15 performs update processing including security processing related to the key transmitted from the Host-side processor 2. For example, in a case where encrypted data is included in the key update information transmitted from the Host-side processor 2, the key information security processing unit 15 performs decryption using a key for the register communication IF to acquire a new key or a key ID.

In addition, in a case where the key update information transmitted from the Host-side processor 2 includes a MAC value, the key information security processing unit 15 performs a MAC operation on encrypted data or the like. The key information security processing unit 15 performs tamper detection by collating the MAC value obtained by the MAC operation with the MAC value added to the encrypted data. The key information security processing unit 15 functions as another security processing unit that performs security processing using a key for the register communication IF. The key information security processing unit 15 outputs information on the new key and the key ID to the image data security processing unit 19.

The synchronization signal generation unit 16 generates a synchronization signal that defines a transmission cycle of frame data, and outputs the synchronization signal to the key switching timing management unit 17. The synchronization signal may be generated on the basis of a signal generated inside the synchronization signal generation unit 16, or the synchronization signal may be generated on the basis of a signal input from the outside of the image sensor 1.

The key switching timing management unit 17 manages a switching timing for the key for the high-speed communication IF. For example, in a case where the update processing is performed by the key information security processing unit 15 and the new key is stored in the register value holding unit 14, the key switching timing management unit 17 determines the next frame data switching timing as the key switching timing on the basis of the synchronization signal generated by the synchronization signal generation unit 16.

In addition, in a case where the update trigger transmitted using the register communication IF is received by the register communication IF unit 13 and the information indicating the reception is stored in the register value holding unit 14, the key switching timing management unit 17 determines the next frame data switching timing as the key switching timing. Information on the key switching timing determined by the key switching timing management unit 17 is supplied to the image data security processing unit 19.

The image data processing unit 18 acquires the pixel data output from the sensor unit 11 and performs application layer processing on the image data of each frame. Frame data having a predetermined format is generated by the processing of the application layer. The image data processing unit 18 outputs data constituting the frame data to the image data security processing unit 19.

The image data security processing unit 19 performs security processing according to the security mode on the basis of the image data of each frame. The key used for the security processing is switched according to the information supplied from the key switching timing management unit 17.

For example, in a case where a security mode for encrypting image data is set, the image data security processing unit 19 encrypts the image data supplied from the image data processing unit 18 using the key for the high-speed communication IF. For encryption of the image data, an IV or the like managed by the image data security processing unit 19 is appropriately used.

In a case where the security mode for performing tamper detection using the MAC value is set, the image data security processing unit 19 calculates the MAC value using the key for the high-speed communication IF.

The image data security processing unit 19 generates frame data in which the key ID of the key used to encrypt the image data is arranged at a predetermined position together with the encrypted image data, and outputs the frame data to the high-speed communication IF unit 12. The frame data appropriately includes a MAC value.

The high-speed communication IF unit 12 performs signal processing of the link layer on the data supplied from the image data security processing unit 19. As the signal processing of the link layer, in addition to the above-described processing, generation of a packet that stores frame data, processing of distributing packet data to a plurality of lanes, and the like are performed.

In addition, the high-speed communication IF unit 12 performs signal processing of the physical layer on the data of each packet. As the signal processing of the physical layer, processing including processing of inserting a control code into a packet distributed to each lane is performed in parallel for each lane. The data stream of each lane is transmitted from the high-speed communication IF unit 12 to the high-speed communication IF unit 21. The high-speed communication IF unit 12 functions as a second communication unit that transmits frame data including image data subjected to the security processing to the Host-side processor 2 using the high-speed communication IF.

### Configuration of Host-Side Processor 2

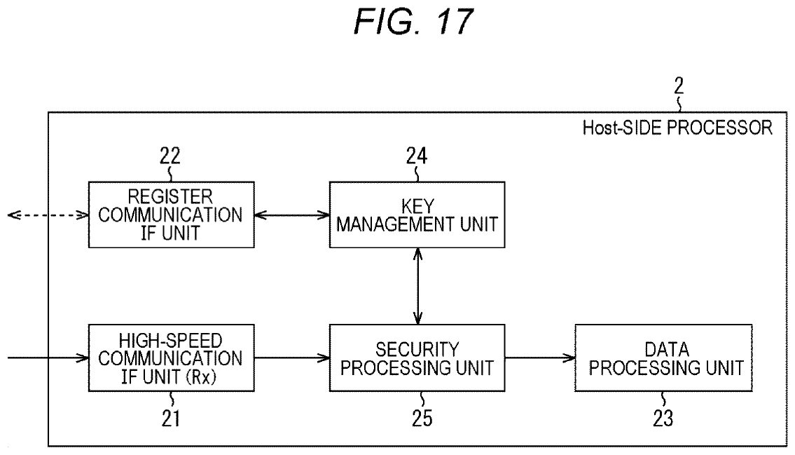

FIG. 17 is a block diagram illustrating a configuration example of the Host-side processor 2. In the configuration illustrated in FIG. 17, the same components as those described above are denoted by the same reference signs. Overlapping description will be omitted as appropriate.

The Host-side processor 2 is provided with a key management unit 24 and a security processing unit 25 in addition to the high-speed communication IF unit 21, the register communication IF unit 22, and the data processing unit 23.

The high-speed communication IF unit 21 receives the data stream transmitted from the high-speed communication IF unit 12, and performs physical layer signal processing on the received data stream. As the signal processing of the physical layer, in addition to the above-described processing, processing including symbol synchronization processing and control code removal is performed in parallel for each lane. By performing the signal processing of the physical layer, a data stream including a packet storing data constituting frame data is generated.

In addition, the high-speed communication IF unit 21 performs signal processing of the link layer on data obtained by the signal processing of the physical layer. As the processing of the link layer, for example, processing of integrating data streams of a plurality of lanes into data of one system and processing of acquiring a packet constituting the data stream are performed.

The high-speed communication IF unit 21 outputs, to the security processing unit 25, frame data including data extracted from a packet acquired by performing the link layer processing. The high-speed communication IF unit 21 functions as a second communication unit that receives frame data transmitted from the image sensor 1 using the high-speed communication IF.

The register communication IF unit 22 performs register communication with the register communication IF unit 13 of the image sensor 1 to transmit and receive various data. The register communication IF unit 22 transmits information such as key update information and an update trigger on the basis of the information managed by the key management unit 24. The register communication IF unit 22 communicates with the image sensor 1 using the register communication IF, and functions as a first communication unit that transmits key update information. The key update information is transmitted in step S21 in FIG. 10, step $51 in FIG. 15, and the like by the processing by the register communication IF unit 22.

The key management unit 24 manages the key for the high-speed communication IF used in each of the image sensor 1 and the Host-side processor 2 in association with a key ID. For example, in a case of performing key update, the key management unit 24 performs security processing such as encrypting a new key and a key ID or obtaining a MAC value by performing a MAC operation using the key for the register communication IF.

The key management unit 24 outputs data obtained by the security processing to the register communication IF unit 22, and causes the register communication IF unit 22 to transmit the data included in the key update information to the Host-side processor 2. In addition, the key management unit 24 controls the register communication IF unit 22 to transmit an update trigger to the image sensor 1.

The security processing unit 25 acquires a key ID arranged at a predetermined position of the frame data supplied from the high-speed communication IF unit 21, and acquires a key for the high-speed communication IF associated with the key ID from the key management unit 24. The security processing unit 25 performs security processing such as decrypting the image data subjected to the security processing or detecting tampering by performing a MAC operation using the key acquired from the key management unit 24. The image data obtained by performing the security processing is supplied to the data processing unit 23.

### Modifications

### Transmission Example of New Key and Key ID

Although the set of the new key and the key ID is transmitted as the key update information to the image sensor 1 at the time of key update, the new key and the key ID may be separately transmitted.

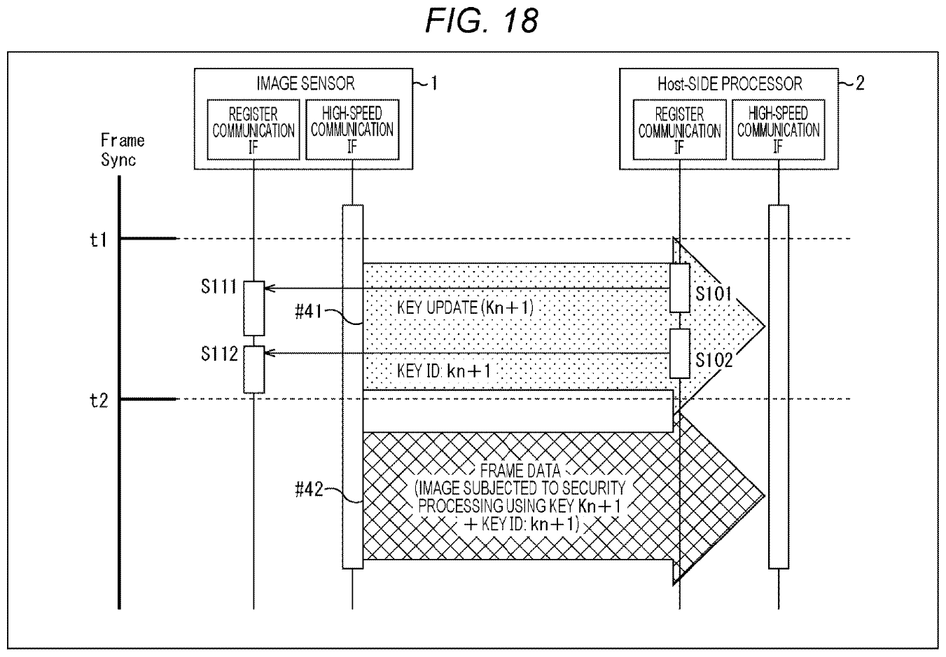

Another flow of key update using the key update information will be described with reference to the sequence of FIG. 18. The description overlapping with the description of FIG. 11 and the like will be appropriately omitted.

As indicated by an arrow #41, frame data including image data subjected to security processing using the key Kn is transmitted from the image sensor 1 to the Host-side processor 2 using the high-speed communication IF. A key IDkn is arranged at a predetermined position of the frame data of the first frame.

In a case where the key update timing is reached during transmission and reception of the frame data of the first frame, the Host-side processor 2 transmits the key update information to the image sensor 1 in step S101. The key update information transmitted to the image sensor 1 includes a key Kn+1 that is a new key.

In step S102, the Host-side processor 2 transmits a key IDkn+1, which is a key ID of the key Kn+1, to the image sensor 1.

In step S111, the image sensor 1 receives the key update information transmitted from the Host-side processor 2, and acquires a new key by decrypting the encrypted key.

In step S112, the image sensor 1 receives the key ID transmitted from the Host-side processor 2.

At time t2, the image sensor 1 switches the key used for the security processing to the key Kn+1, and starts transmitting the frame data of the second frame as indicated by an arrow #42. The frame data of the second frame includes image data subjected to security processing using the key Kn+1. In addition, a key IDkn+1, which is a key ID of the key Kn+1, is arranged at a predetermined position of the frame data of the second frame.

As described above, also by transmitting the new key and the key ID separately, the image sensor 1 can generate frame data in which the key ID is arranged and notify the Host-side processor 2 of which key is the key used for the security processing.

### Example of Output Data

Although the frame data is generated using the image data of each frame captured by the sensor unit 11 as the output data and transmitted to the Host-side processor 2, other types of data in units of frames may be used as the output data. For example, a distance image in which the distance to each position of the subject is a pixel value of each pixel can be used as the output data.

### Others

The above-described series of processing can be executed by hardware or software. In a case where the series of processing is executed by software, a program constituting the software is installed from a program recording medium to a computer incorporated in dedicated hardware, a general-purpose personal computer, or the like.

The program to be installed is provided by being recorded in a removable medium such as an optical disk (CD-ROM (Compact Disc-Read Only Memory), DVD (Digital Versatile Disc), and the like) or a semiconductor memory. In addition, it is provided via a wired or wireless transmission medium such as a local area network, the Internet, and digital broadcasting. The program can be installed in advance in the ROM or the storage unit of the device.

Note that the program executed by the computer may be a program in which processing is performed in time series in the order described in the present specification, or may be a program in which processing is performed in parallel or at necessary timing such as when a call is made.

In the present specification, a system means a set of a plurality of components (apparatuses, modules (parts), or the like), and it does not matter whether or not all the components are in the same housing. Therefore, a plurality of apparatuses housed in separate housings and connected via a network and one apparatus in which a plurality of modules is housed in one housing are both systems.

The effects described in the present specification are merely examples and are not limited, and other effects may be provided.

The embodiments of the present technology are not limited to the above-described embodiments, and various modifications can be made without departing from the gist of the present technology.

### Example of Combination of Configurations

The present technology can also have the following configurations.
(1)

An information processing apparatus including:
a first communication unit that receives a new key transmitted from an apparatus as a transmission destination of output data by using a first communication IF in a case where a key used for security processing on the output data of each frame is updated, and a key ID which is identification information of the new key;
a security processing unit that performs the security processing using the new key and generates frame data in a predetermined format including the output data after the security processing and the key ID of the key used for the security processing; and
a second communication unit that transmits the frame data to the apparatus by using a second communication IF.
(2)

The information processing apparatus according to (1),
in which the first communication unit receives the new key and the key ID encrypted in the apparatus using a key for the first communication IF,
the information processing apparatus further including another security processing unit that decrypts the new key and the key ID using the key for the first communication IF.
(3)

The information processing apparatus according to (1),
in which the first communication unit receives the new key encrypted in the apparatus using a key for the first communication IF and the key ID added to encrypted data of the new key,
the information processing apparatus further including another security processing unit that decrypts the new key using the key for the first communication IF.
(4)

The information processing apparatus according to any one of (1) to (3),
in which the security processing unit performs encryption using the new key as the security processing and generates the frame data including encrypted data of the output data.
(5)

The information processing apparatus according to (4),
in which the security processing unit performs calculation of a MAC value using the new key as the security processing and generates the frame data including the MAC value obtained by the calculation.
(6)

The information processing apparatus according to any one of (1) to (5),
in which the security processing unit generates the frame data in which the key ID is arranged as information constituting additional information of the output data.
(7)

The information processing apparatus according to any one of (1) to (5),
in which the security processing unit generates the frame data in which the key ID is arranged as information constituting security-related information that is information used for implementing security of the output data.
(8)

The information processing apparatus according to (4) or (5),
in which the security processing unit generates the frame data in which the key ID is arranged as information constituting an initial vector used together with the new key for encryption of the output data.
(9)

The information processing apparatus according to any one of (1) to (8),
in which the security processing unit switches the key used for the security processing to the new key at a switching timing of the output data as a target of the security processing.
(10)

The information processing apparatus according to (9),
in which the security processing unit switches the key used for the security processing to the new key in response to transmission of trigger information from the apparatus using the first communication IF.
(11)

The information processing apparatus according to any one of (1) to (10), further including
a sensor unit that outputs image data of each frame as the output data.
(12)

An information processing method in which an information processing apparatus is configured to:
receive a new key transmitted from an apparatus as a transmission destination of output data by using a first communication IF in a case where a key used for security processing on the output data of each frame is updated, and a key ID which is identification information of the new key;
perform the security processing using the new key and generate frame data in a predetermined format including the output data after the security processing and the key ID of the key used for the security processing; and
transmit the frame data to the apparatus by using a second communication IF.
(13)

A program for causing a computer to execute processing of:
receiving a new key transmitted from an apparatus as a transmission destination of output data by using a first communication IF in a case where a key used for security processing on the output data of each frame is updated, and a key ID which is identification information of the new key;
performing the security processing using the new key and generating frame data in a predetermined format including the output data after the security processing and the key ID of the key used for the security processing; and
transmitting the frame data to the apparatus by using a second communication IF.
(14)

An information processing apparatus including:
a first communication unit that transmits a new key and a key ID that is identification information of the new key to an apparatus that is a transmission source of output data by using a first communication IF in a case where a key used for security processing on the output data of each frame is updated;
a second communication unit that receives frame data in a predetermined format including the output data after the security processing and the key ID of the key used for the security processing transmitted from the apparatus using a second communication IF; and
a security processing unit that performs the security processing on the output data included in the frame data using the new key identified by the key ID included in the frame data.
(15)

The information processing apparatus according to (14), further including
a key management unit that encrypts the new key and the key ID using a key for the first communication IF,
in which the first communication unit transmits encrypted data of the new key and the key ID to the apparatus.
(16)

The information processing apparatus according to (14), further including
a key management unit that encrypts the new key using a key for the first communication IF,
in which the first communication unit adds the key ID to encrypted data of the new key and transmits the encrypted data to the apparatus.
(17)

An information processing method in which an information processing apparatus is configured to:
transmit a new key and a key ID that is identification information of the new key to an apparatus that is a transmission source of output data by using a first communication IF in a case where a key used for security processing on the output data of each frame is updated;
receive frame data in a predetermined format including the output data after the security processing and the key ID of the key used for the security processing transmitted from the apparatus using a second communication IF; and
perform the security processing on the output data included in the frame data using the new key identified by the key ID included in the frame data.
(18)

A program for causing a computer to execute processing of:
transmitting a new key and a key ID that is identification information of the new key to an apparatus that is a transmission source of output data by using a first communication IF in a case where a key used for security processing on the output data of each frame is updated;
receiving frame data in a predetermined format including the output data after the security processing and the key ID of the key used for the security processing transmitted from the apparatus using a second communication IF; and
performing the security processing on the output data included in the frame data using the new key identified by the key ID included in the frame data.
(19)

A communication system including:
a first information processing apparatus including
a first communication unit that receives a new key transmitted from an apparatus as a transmission destination of output data by using a first communication IF in a case where a key used for security processing on the output data of each frame is updated, and a key ID which is identification information of the new key,
a security processing unit that performs the security processing using the new key and generates frame data in a predetermined format including the output data after the security processing and the key ID of the key used for the security processing, and
a second communication unit that transmits the frame data to the apparatus by using a second communication IF; and
a second information processing apparatus including
a first communication unit that transmits the new key and the key ID to the first information processing apparatus that is a transmission source of the output data using the first communication IF in a case where the key used for the security processing is updated,
a second communication unit that receives the frame data transmitted from the first information processing apparatus by using the second communication IF, and
a security processing unit that performs the security processing on the output data included in the frame data using the new key identified by the key ID included in the frame data.

### REFERENCE SIGNS LIST

1 Image sensor
2 Host-side processor
11 Sensor unit
12 High-speed communication IF unit
13 Register communication IF unit
14 Register value holding unit
15 Key information security processing unit
16 Synchronization signal generation unit
17 Key switching timing management unit
18 Image data processing unit
19 Image data security processing unit
21 High-speed communication IF unit
22 Register communication IF unit
23 Data processing unit
24 Key management unit
25 Security processing unit

1. An information processing apparatus comprising:
a first communication unit that receives a new key transmitted from an apparatus as a transmission destination of output data by using a first communication IF in a case where a key used for security processing on the output data of each frame is updated, and a key ID which is identification information of the new key;
a security processing unit that performs the security processing using the new key and generates frame data in a predetermined format including the output data after the security processing and the key ID of the key used for the security processing; and
a second communication unit that transmits the frame data to the apparatus by using a second communication IF.

2. The information processing apparatus according to claim 1,
wherein the first communication unit receives the new key and the key ID encrypted in the apparatus using a key for the first communication IF,
the information processing apparatus further comprising another security processing unit that decrypts the new key and the key ID using the key for the first communication IF.

3. The information processing apparatus according to claim 1,
wherein the first communication unit receives the new key encrypted in the apparatus using a key for the first communication IF and the key ID added to encrypted data of the new key,
the information processing apparatus further comprising another security processing unit that decrypts the new key using the key for the first communication IF.

4. The information processing apparatus according to claim 1,
wherein the security processing unit performs encryption using the new key as the security processing and generates the frame data including encrypted data of the output data.

5. The information processing apparatus according to claim 1,
wherein the security processing unit performs calculation of a MAC value using the new key as the security processing and generates the frame data including the MAC value obtained by the calculation.

6. The information processing apparatus according to claim 1,
wherein the security processing unit generates the frame data in which the key ID is arranged as information constituting additional information of the output data.

7. The information processing apparatus according to claim 1,
wherein the security processing unit generates the frame data in which the key ID is arranged as information constituting security-related information that is information used for implementing security of the output data.

8. The information processing apparatus according to claim 4,
wherein the security processing unit generates the frame data in which the key ID is arranged as information constituting an initial vector used together with the new key for encryption of the output data.

9. The information processing apparatus according to claim 1,
wherein the security processing unit switches the key used for the security processing to the new key at a switching timing of the output data as a target of the security processing.

10. The information processing apparatus according to claim 9,
wherein the security processing unit switches the key used for the security processing to the new key in response to transmission of trigger information from the apparatus using the first communication IF.

11. The information processing apparatus according to claim 1, further comprising
a sensor unit that outputs image data of each frame as the output data.

12. An information processing method in which an information processing apparatus is configured to:
receive a new key transmitted from an apparatus as a transmission destination of output data by using a first communication IF in a case where a key used for security processing on the output data of each frame is updated, and a key ID which is identification information of the new key;
perform the security processing using the new key and generate frame data in a predetermined format including the output data after the security processing and the key ID of the key used for the security processing; and
transmit the frame data to the apparatus by using a second communication IF.

13. A program for causing a computer to execute processing of:
receiving a new key transmitted from an apparatus as a transmission destination of output data by using a first communication IF in a case where a key used for security processing on the output data of each frame is updated, and a key ID which is identification information of the new key;
performing the security processing using the new key and generating frame data in a predetermined format including the output data after the security processing and the key ID of the key used for the security processing; and
transmitting the frame data to the apparatus by using a second communication IF.

14. An information processing apparatus comprising:
a first communication unit that transmits a new key and a key ID that is identification information of the new key to an apparatus that is a transmission source of output data by using a first communication IF in a case where a key used for security processing on the output data of each frame is updated;
a second communication unit that receives frame data in a predetermined format including the output data after the security processing and the key ID of the key used for the security processing transmitted from the apparatus using a second communication IF; and
a security processing unit that performs the security processing on the output data included in the frame data using the new key identified by the key ID included in the frame data.

15. The information processing apparatus according to claim 14, further comprising
a key management unit that encrypts the new key and the key ID using a key for the first communication IF,
wherein the first communication unit transmits encrypted data of the new key and the key ID to the apparatus.

16. The information processing apparatus according to claim 14, further comprising
a key management unit that encrypts the new key using a key for the first communication IF,
wherein the first communication unit adds the key ID to encrypted data of the new key and transmits the encrypted data to the apparatus.

17. An information processing method in which an information processing apparatus is configured to:
transmit a new key and a key ID that is identification information of the new key to an apparatus that is a transmission source of output data by using a first communication IF in a case where a key used for security processing on the output data of each frame is updated;
receive frame data in a predetermined format including the output data after the security processing and the key ID of the key used for the security processing transmitted from the apparatus using a second communication IF; and
perform the security processing on the output data included in the frame data using the new key identified by the key ID included in the frame data.

18. A program for causing a computer to execute processing of:
transmitting a new key and a key ID that is identification information of the new key to an apparatus that is a transmission source of output data by using a first communication IF in a case where a key used for security processing on the output data of each frame is updated;
receiving frame data in a predetermined format including the output data after the security processing and the key ID of the key used for the security processing transmitted from the apparatus using a second communication IF; and
performing the security processing on the output data included in the frame data using the new key identified by the key ID included in the frame data.

19. A communication system comprising:
a first information processing apparatus including
a first communication unit that receives a new key transmitted from an apparatus as a transmission destination of output data by using a first communication IF in a case where a key used for security processing on the output data of each frame is updated, and a key ID which is identification information of the new key,
a security processing unit that performs the security processing using the new key and generates frame data in a predetermined format including the output data after the security processing and the key ID of the key used for the security processing, and
a second communication unit that transmits the frame data to the apparatus by using a second communication IF; and
a second information processing apparatus including
a first communication unit that transmits the new key and the key ID to the first information processing apparatus that is a transmission source of the output data using the first communication IF in a case where the key used for the security processing is updated,
a second communication unit that receives the frame data transmitted from the first information processing apparatus by using the second communication IF, and
a security processing unit that performs the security processing on the output data included in the frame data using the new key identified by the key ID included in the frame data.
